(19) United States
(12) Patent Application Publication
(10) Pub. No.: US 2003/0061163 A1
(43) Pub. Date: Mar. 27, 2003

(54) Method and apparatus for verification/authorization by credit or debit card owner of use of card concurrently with merchant transaction

(76) Inventor: Richard C. Durfield, La Verne, CA (US)

Correspondence Address: Ben E. Lofstedt, P.O. Box 4189, Fullerton, CA, 92834, US

(21) Appl. No.: 09/966,336

(22) Filed: Sep. 27, 2001

(51) Int. Cl. G06F 17/60

(52) U.S. Cl. 705/44

(57) ABSTRACT

A method and apparatus for protecting against the unauthorized use of a credit card called CardSafe™ allows the credit card holder to finally approve any credit card transaction. When a credit card is used at a remote merchant's terminal, the credit card company is notified of the transaction amount and the credit card account number. The named card holder is concurrently notified of the transaction by a wireless device, such as a telephone call, pager notification, or the like. Upon notification, the card holder can approve or disapprove of the credit card transaction. Unless approved or denied by the credit card holder, the transaction remains uncompleted. The approval or disapproval by the credit card holder can be accomplished in real time or on a pre-selected basis. An unauthorized person would not be able to complete a transaction The credit card owner can also deactivate the CardSafe™ system.

### BACKGROUND OF THE INVENTION

1. Field of the Invention

The field of the invention herein relates to a credit or debit card use verification system and method to prevent credit card fraud and unauthorized transactions, and, more particularly, to a credit card use verification system whereby authorization and use of the credit card in a credit card transaction is authorized and verified by both the credit card holder and by the credit card company concurrently with the credit card transaction through the use of wireless technology, including, telephone systems, such as hard wired (“land” lines), a telephone call, pager notification, wireless, Research In Motion (“RIM®”), Wireless Application Protocol (“WAP”), Bluetooth®, Blackberry®, the Internet, or by satellite.

2. Description of the Prior Art

One of the major problems facing the retail business today is that the use of credit cards, debit cards and other similar financial documents today involves a less than secure transaction. Anyone who uses the Internet is attaching their computer to an immense network. Such attachment exposes the hard drive on your computer to unwelcomed, and usually, unauthorized, intruders making your personal behavior as manifested through the uniquely particular use of your computer wide-open to snoopers. Some such intrusions will damage the hard drive in your computer. The data and information contained on the hard drive can be analogized as the equivalent to a “rotating electronic personal file cabinet.” If your hard drive is damaged, erased or modified, the result can be the same as if your “rotating electronic personal file cabinet” was stolen or partially or fully destroyed by fire all of which results in the loss of data and information.

Identity theft is sky-rocketing. And, this identity theft is occurring at a time in history when commercial transactions performed over the Internet represent one of the fastest growing phenomena that the world of commerce has ever experienced or seen. The growth of world-wide public packet-switched computer networks presages that vast commercial potential for a new type of open marketplace for both goods and services. Such a network sales system which incorporates a multiplicity of buyer and merchant computers, means for the users of the buyer companies to display digital advertisements from the merchant computers, and means for the users to purchase products in the network advertisements. Among other things, such a shopping system must be allowed to include easy-to-use facilities for a user to purchase products using a merchant payment method. Such network sales will need to allow new buyers and merchants to enter the market.

Central to any such network or virtual marketplace is a payment mechanism for such offered goods and services. Such payment mechanism includes the utilization of presently conventional financial instruments such as credit cards, debit cards, and demand deposit account balances. Of necessity, both retail and wholesale payment mechanisms will be required for networks, with consumers using the retail mechanism. For the widest possible acceptance, the retail mechanism will need to be logical evolution of existing credit-card, debit card and Automated Clearing House facilities, while for acceptance the wholesale mechanism will need to be an evolved version of corporate electronic funds transfer.

Present network payment systems do not directly communicate with, or seek the authorization, from the credit issuing companies or the credit card holder at the commencement of the credit card transaction. Many are not compatible with presently used financial instruments associated with transfers of money.

Some of the existing network payment systems include the Simple Network Payment Protocol [Dukach, S., SNPP: A Simple Network Payment Protocol, MIT Laboratory for Computer Science, Cambridge, Mass., 1993.], Sirbu's Internet Billing Server [Sirbu, M. A., Internet Billing Service Design and Prototype Implementation, Information Networking Program, Carnegie-Mellon University, 1993], and NetCash [Medvinsy, G., and Newman, B. C., Net Cash: A Design for Practical Electronic Currency on the Internet, Proc. 1^{st}. ACM Conference on Computer and Communication Security, November, 1993.]

Credit card transactions are being utilized in a variety of environments. In one type of typical environment a user provides a merchant with a credit card, and the merchant, through various means, will verify whether that information is accurate. In one such system, a merchant receives a credit card from the Customer. The merchant then verifies the credit card through an automated verification system by swiping the card and sending the electronic data contained in the credit card through a modem to a remotely-located credit card verifying and authenticating center. These systems work well in a credit card transaction in which either the customer has a face-to-face meeting with the merchant or the merchant is actually shipping a package or the like to the address of a customer. Such a procedure typically includes receiving a the Automatic Verification System (“AVS”) address information and identity information. However, when downloading information from an online service or the Internet, the address and identity information are not enough to adequately verify that the customer who is ordering the goods is actually the owner of the credit card being used in the transaction. For example, an individual may have both the name and the address of a particular credit card holder and that information in a normal transaction may be sufficient for the authorization of such a transaction. However, in an Internet transaction it is impossible to obtain all the correct information related to the particular credit card holder through unscrupulous means and, therefore, another person other than the true credit card holder may be able to fraudulently obtain information about the real credit card holder to “fool” the system into incorrectly believing that this particular person using the credit card in this transaction has the authorization to do so. Accordingly, what is needed is a system and method which overcomes the problems associated with the typical verification system for credit card transactions particularly in the Internet or online services environment. Such a system should be easily implemented within the existing environment and should also be straightforwardly applicable to existing technology such as wireless, Research In Motion (“RIM®”), Wireless Application Protocol (“WAP”), Bluetooth®, Blackberry®, Internet, cell phone, FM broadband wireless technology, DSL, ADSL, T-1, Fractional T-1, and the like. The invention disclosed herein addresses such a need and fulfills it.

Wireless Application Protocol (“WAP”) provides wireless devices, such as cell phones and Personal Data Assistants (“PDAs”) with the ability to access data networks such as the Internet and Intranets. WAP is frequently touted as the Web on your phone. However, WAP is best thought of as being the first step in bringing wireless data services to the mass market. WAP had its origins in 1995 in a small United States company named Libris, Inc. obtained its initial funding, set up its first offices, and demonstrated early versions of a phone-based browser system at COMDEX. In 1996, Libris, Inc. was re-named Unwired Planet and released its first commercial service in the form of AT&T Wireless PocketNet which enabled receipt of e-mail messages and stock market quotes wirelessly. Qualcomm invested in Unwired Planet in 1997, and, as a result, several new services were spawned; namely, SuperPhone with GTE Wireless, and Bell Atlantic's Mobile Cellscape. In mid-1997, following the release of its second generation browser and server software, Unwired Planet co-founded the WAP Forum with Ericsson, Nokia and Motorola. WAP co-founders, Ericsson, Nokia and Motorola had also been busy developing their own wireless data solutions which tended to leverage lessons learned from the Web. Ericsson had developed Intelligent Terminal Transfer Protocol (“ITTP”) and Nokia was involved with Narrow Band Sockets and a markup language called Tagged Text Markup Language (“TTML”). In May of 1998, the WAP Forum published its first standard, a protocol that combined the best of the participant's technologies ITTP, Narrow Band Sockets, and Unwired Planet's HDML—Handheld Device Markup Language): WAP 1.0. Independent of the bearer, WAP works over different underlying networks and is not limited to working with the Global System for Mobile (“GSM”). By July 2000, the WAP Forum's membership had grow to over 530 companies. In April 1999, Unwired Planet became Phone.com and is now known as Openwave Systems. Current efforts within the United Kingdom have focused on marketing WAP as a consumer device, primarily through developing key services, such as banking. Other developments including bandwidth increases and the always one capability of phones, WAP services will become more useful. Larger color screens are planned along with interactive voice commands with the applications, along with improved wireless portals with intelligent, personalization of consumer services with location-based services that deliver content based upon a user's current location. It is anticipated that with the implementation of WAP, commerce should come to phones.

The Wireless Application Environment specification establishes guidelines for development applications for the WAP environment. All major cell phone, PDA, and other wireless device manufacturers are engaged in the development of various WAP-compatible devices. Such WAP-compatible devices makes them suitable for use as Network Management Software (“NMS”). It is anticipated that existing NMS can be made WAP capable by the development of adapter modules which will extract the data from the NMS and convert it to the WAP format.

In the present credit card transactional authorization system, once the credit card account number is made known to other people, under the present credit card system, the account number alone without the actual credit card can be used to charge against the particular credit card account, or otherwise, access the credit card holder's account.

One such method is the now classic method of rummaging through paper trash receptacles, such as waste baskets or trash dumpsters, for the customer's credit card transaction receipt which has been carelessly tossed away by the credit card holder or user. Credit card users are cautioned to always take and kept their copy of the credit card transactions.

Recently, a more sophisticated method has been recently introduced as a means for unlawfully obtaining credit card account numbers, is to electronically hook up a Palm VII, or the like, which are referred to as Personal Digital Assistants (“PDA”) to the credit card swipe-type electronic data entry machine to accumulate all credit card customers' account numbers that have been swiped during the period of time that the PDA is electronically connected to the electronic data entry machine. Such electronic connections can be made by use of wireless technology, wired technology such as RS232, or RS435, hard-wired, cable hook up, or even infrared. Should infrared or wireless be used, the PDA can be placed remotely from the place where the credit card transaction occurs. Such remote connections render it very difficult, if not impossible, to locate and detect such covert and hidden devices. Once such otherwise private credit card account numbers are recorded, these credit card account numbers are then made available on the Internet for “sale” to be used in fraudulent schemes by persons unauthorized to use these credit card accounts.

The increasingly wide-spread use of the ultimate of public networks, namely, the Internet, has increased the risk of losses to the merchants due to credit card fraud in the retail marketplace. Such risk of loss to the companies involved in the payment system is increased by current statutory patterns which hold the payment system operator responsible, at least for some, of the security failures of the credit card holders and the merchants. Under the Consumer Credit Protection Act (“CCPA”) and the Electronic Funds Transfer Act (“EFTA”) the credit card companies are required, in many situations, to limit the liability of the consumer to pay for the losses incurred. Additionally, credit card companies have certain legal responsibilities for large scale, or wholesale, transactions.

The issuer of the credit card in the vast majority of the present day credit card payment systems assumes the risk of fraud associated with abuse or misuse of the credit card, provided, however, if the merchant has followed the established credit card acceptance methodologies or protocols. Such methodologies include verifying the signature of a card holder on the obverse side of the credit card to the signature on the credit card transaction receipt, and requesting authorizations from the credit card issuer concerning a particular amount of money. However, in the event that the business transaction occurs over the Internet, or the like, a merchant cannot, in most cases, physically examine a purchaser's credit card. Consequently, the risk of loss due to fraud typically is on the merchant in such “card not present” transactions. With the limited financial resources of many merchants, such merchants are not in a position to embrace such risk due to their limited financial resources. With this in mind, through the invention described herein, a significantly greater number of merchants will, because of the lowered risk of loss involved, be willing to conduct business transactions over the Internet.

With the further introduction of such highly sophisticated computer and electronics programs and hardware such as ECHELON® or CARNIVOIRE®, the security of the use of credit cards is further comprised.

One such the prior art systems involving transaction oriented verification systems, U.S. Pat. No. 5,826,245 (Erik Sandberg-Diment) there is taught a transaction verification system where the transaction is verified via tokens. A method and apparatus is disclosed for giving verification information with respect to a transaction between an initiating party and a verification-seeking party, the verification information being given by a third, verifying party, based on confidential information in the possession of the third party. On behalf of the initiating party, first and second tokens are generated, each token representing some, but not all, of the confidential information. The initiating party sends one token to the verification-seeking party and one token to the verifying party. The verification-seeking party sends the token received to the verification-seeking party. The confidential information is then verified by the verifying party based upon the first and second tokens. Verification information is sent by the verifying party electronically via a non-secured network to the verification-seeking party. The confidential information, for example, the credit card number, is not available on any one link. It is only available to the credit card holder as an entire block AND the verifying agent, and NOT to the verification-seeking party, such as a merchant.

The merchant never receives the entire credit card number but only a tagged piece of information AND an approval code. Consequently, the credit card number is never available as a whole except at the consumer's computer and at the verification agent. The entire process for accomplishing this method is detailed in a process-flow chart as FIG. 3 of the drawings to this patent.

In another prior art system and method involving transactional authorizations, in U.S. Pat. No. 5,991,750 (Craig Watson) relates to a system and method for pre-authorization of individual account transactions that would otherwise be completely denied authorization using only general authorization parameters. FIG. 4 of the drawings depicts the entire flow process for this patented system and method. Such a pre-authorization use of a credit card contains within it the same basic problems are as encountered and associated with the present or current credit card use, authorization and verification systems.

In U.S. Pat. No. 6,012,144 (Thomas E. Pickett), a patent issued on Jan. 4, 2000, the concept of making a purchase over the Internet or the public telephone is presented. This system automatically contacts the person back to verify the transaction. A person wishing to initiate a secure transaction sends a message over one of the non-secure networks to a computer. The computer then automatically uses the second non-secure network to contact the person back to verify the transaction. The call-back mechanism employs a method to authenticate the identity or authority of the person initiating the transaction. The entire process is shown in detail in FIGS. 1 and 2 of the drawings. However, it is quite clear that this system is limited to the use of a very insecure, and public, Internet communications system.

Another United States Patent recently issued on Jan. 25, 2000, namely: U.S. Pat. No 6,018,724 (Michael A. Arent) relates to a method and apparatus for authenticating and verifying data related to electronic transactions AND for providing positive confirmation to a user of such authentication and verification. The invention utilizes a user-customized certification indicator that informs a user as to the success or failure of one or more authentication and/or security protocols implemented on a used on a personal computer (“PC”), a network computer (“NC”), a personal digital assistant (“PDA”), an enhanced function telephone (ETel), or the like.

For example, in the method taught by U.S. Pat. No 6,018,724, in browsing the Internet, a merchant's web page is encountered. To check the identity of the on-line merchant, the purchaser through a previous contact has arranged for certification of the merchant through an entity trusted by the purchaser. To check the authenticity of the on-line merchant, the PDA, or NC, or PC, or ETel, The trusted entity may be a certification authority that evaluates and certifies merchants. Once this is done, digital certificates are issued to certified merchants, or the merchant is included in a database of certified merchants maintained by the certification authority. Such a method obviously has value. However, it embraces even greater transactional and technical difficulties than it attempts to solve.

U.S. Pat. No. 6,023,682 (Robert A. Checchio) was issued on Feb. 8, 2000. In this patent, the inventor notes that current credit care authorization devices are incapable of determining whether the holder of the credit card is authorized to use the credit card. At present, there is no device or method that can be used during a sale which quickly, inexpensively, reliably and without embarrassment to the vendor determines whether a user is authorized to use a particular credit card. It uses a Personal Identification Code (“PIC”) which is stored in the computer's memory. The PIC must be matched in order for the transaction to be validated. Alternatively, certain personal information must be first inputted into a computer and this information is compared with the new one. Still further, an information transmitter connected to the credit card validation unit for communicating information to a user of the device is envisioned. In turn, a communicator connected to the credit car validation unit communicates credit card data to a separate main computer. The method and process described does not perform a “call-back” to verify genuine authorization status to the owner of the credit card. However, the use of a PIC, or a similar (or same) so-called “Personal Identification Number” (“PIN”) is fraught with a number of problems not the least of which is the fact that there are an estimated one hundred and twenty million (120,000,000) credit card users throughout just the United States of America, but just one of the major private credit reporting agencies, TRW (now “Experian”), has an estimated seven hundred million (700,000,000) “PINs” belonging to only 120,000,000 credit card users. Because of this large discrepancy, the identity of the credit card users cannot reliably be authenticated within any reasonable degree of certitude.

The invention found in U.S. Pat. No. 6,029,154 (John Phillip Pettitt), a patent issued on Feb. 22, 2000, relates to a method and system for verifying the credit card information based upon a variety of parameters. The variety of parameters are weighted so as to provide a merchant with a quantifiable indication of whether the credit card transaction is fraudulent. Again, this methodology fails to provide reliable, confident identification of the credit card user and, because of this, no solution to the current problems inherent in the present credit card verification and/or authorization system are overcome.

One of the most recently issued patents is U.S. Pat. No. 6,047,268 (Paul D. Bartoli, et al.) which was issued on Apr. 4, 2000. A credit card authorization and verification method is disclosed which uses a trusted transaction intermediary to authenticate the user on the World Wide Web (“WWW”) and authorizs a transaction. One of the biggest difficulties encountered by this methodology is that credit card user must first, however, register with the provider of the billing system. Information previously provided to the user's client terminal's COOKIE file is transmitted to a billing server within the billing system. This information comprises a static information portion and a transaction oriented dynamic information portion, which are encrypted prior to transmission. The STATIC information portion identified the user through an assigned account number. The TRANSACTION ORIENTED DYNAMIC INFORMATION portion comprises at least one sequence that was sent to the user's COOKIE file by the billing server upon a previous transaction, and is valid for only a single new transaction. In short, this transaction verification requires that a separate trusted billing organization be involved, and the user verifies a future transaction before even considering a specific transaction. In short, there is no final user approval of the transaction; the credit card transaction is, in essence, pre-approved. All pre-approval credit card transaction systems inherently have the same problems as with the existing credit card transactional system, and, therefore, offer no real solution to the myriad of problems encountered in the implementation of the present credit card transactional system.

U.S. Pat. No. 6,049,785 (David K. Gifford) was issued on Apr. 11, 2000. Shown and disclosed in U.S. Pat. No. 6,049,785 is a complete system for the purchasing of goods or information over a computer network is presented. Payment orders are backed by accounts in an external financial system network, and the payment system obtains account authorizations from this external network in real-time. In one aspect of this system, it is envisioned that the network payment system sends messages into a financial authorization system in real-time before the network payment system will authorize a payment order. This authorization system is not personal and real-time, or credit card oriented. It is a database system.

It is noted that in two of these prior art patents, there was found to specifically mention a call-back method to authenticate the identity or authority of the person initiating the transaction is U.S. Pat. No. 6,012,144 (Thomas E. Pickett) and U.S. Pat. No. 6,049,785 (David K. Gifford). U.S. Pat. No. 6,012,144 (Thomas E. Pickett), teaches the concept of making a purchase over the Internet or the public telephone, the system automatically contacts the person back to verify the transaction. A person wishing to initiate a secure transaction sends a message over one of the non-secure networks to a computer. The computer then automatically uses the second non-secure network to contact the person back to verify the transaction. The call-back mechanism employs a method to authenticate the identity or authority of the person initiating the transaction. The entire process is shown in detail in FIGS. 1 and 2 of the drawings.

In U.S. Pat. No. 6,049,785 (David K. Gifford) requires, in one aspect of the invention, that the network payment system sends messages into a financial authorization system in real-time before the network payment system will authorize a payment order.

Neither U.S. Pat. No. 6,012,144 (Thomas E. Pickett) and U.S. Pat. No. 6,049,785 (David K. Gifford).offer the features and unique characteristics of the within invention by the applicant herein to protect, preserve and secure the credit card transaction to which the present invention disclosed herein is addressed.

### SUMMARY OF THE INVENTION AND OBJECTS

Fundamently, the invention disclosed herein is a system and a method designed for credit card protection called CARDSAFE™. CARDSAFE™ protects the credit card holder by allowing the named credit card holder to assert a final APPROVAL over the transaction immediately just prior to the consummation of any and all transactions associated with a particular credit card or debit cards, or other type of charge card. The method consists of the following activities. At the time that a particular credit card is used in a credit card transaction at a remote terminal, the credit card processing company is contacted with the amount of the transaction and the account number. Concurrently, the card holder is immediately notified by one or more of the currently available electronic or wireless technologies, such as a telephone call, pager notification, wireless, Bluetooth®, Blackberry®, or the Internet. Upon receipt of this notification, the credit card holder will either approve or disapprove of the credit card transaction by using one or more of the currently available electronic or wireless technologies, such as a telephone call, pager notification, wireless, Bluetooth®, Blackberry®, satellite or the Internet. Unless or until the transaction is approved by the credit card holder, the transaction is not completed. Following notification to the credit card holder, approval or disapproval by the credit card holder can be real time or on a pre-approval or pre-disapproval basis. No credit card transactions can be effectuated without providing the named owner of the credit card an opportunity to approve of, or disapproved of, the credit card transaction. In this way, an unauthorized person who gains access to a particular account would not be able to complete a transaction At the choice of the credit card owner, the CARDSAFE™ system can also be deactivated if desired. The CARDSAFE™ system is designed to work with any and all types of wireless, and wired, systems such as telephones, pagers, microwave, Internet and computers.

One significant and important object of the invention is to provide a concurrent method for conveniently verifying and authorizing a credit card transaction at the very moment the merchant initiates the transaction.

Another significant feature and characteristic of the present invention is to provide a method for preventing the credit card transaction from being completed until it is approved by the card holder.

A yet still further important feature of the instant invention is to provide a system incorporating a method for giving the credit card holder the final say-so in the form of an approval of the credit card transaction before the credit card transaction is consummated.

The present invention incorporates a pre-designated phone number so that the merchant who initiates the credit card transaction will either directly, or indirectly (that is, through an intermediary), concurrently activate such pre-designated phone number which calls or notifies the card holder or owner at the very same time of the attempted merchant card transaction.

Other goals, features and objects of the invention disclosed herein are not to be construed as merely being limited to credit card transactions, but are intended to incorporate other types of financial documents such as debit cards and demand deposit accounts for merchants and payments.

A yet still further object of the present invention is to provide a network payment system that will authorize payment orders and remove a portion of the risk of fraud from the merchants engaged in Wireless Application Protocol (“WAP”) commerce and financial transactions.

These and other advantages and features of the present invention will become better understood from the following detailed description of one embodiment of the invention which is described in conjunction with the accompanying drawings and exhibits.

### BRIEF DESCRIPTION OF THE DRAWINGS

Other objects, features, and advantages of the invention will appear from the following description taken together with the drawings in which:

FIG. 1 represents a functional, interactive block diagram of the broad overview of the basic and fundamental concept of the new and unique CardSafe™ method of verifying that a particular user of the credit or debit card is authorized by the owner of the credit or debit card to engage in the transaction concurrently with the input of the card data by the merchant of services or goods at the time of the card transaction.

### DESCRIPTION OF A PARTICULAR PREFERRED EMBODIMENT

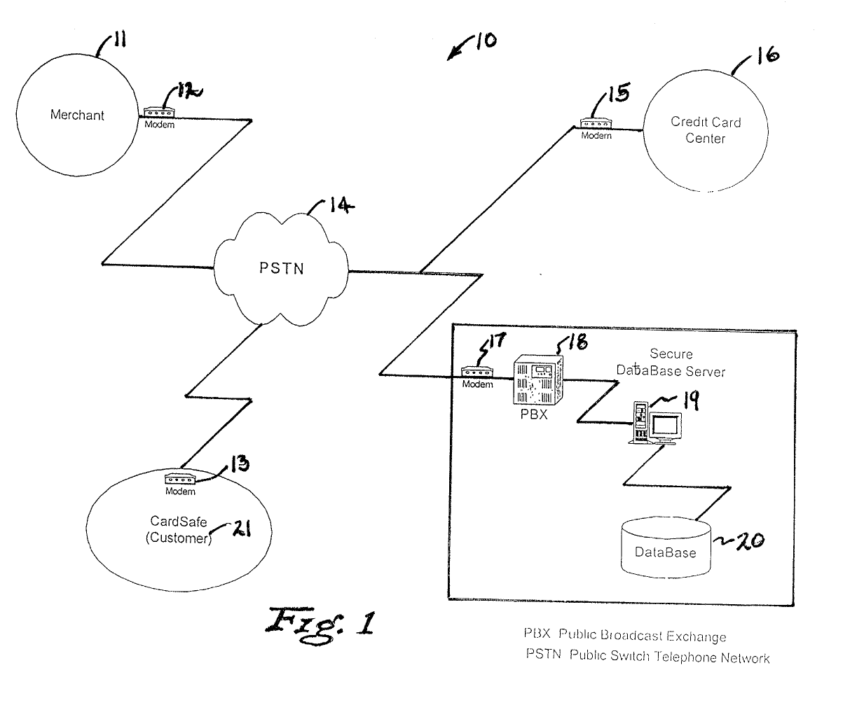

With continuing reference to all of the drawings herein, and with special emphasis now on the drawing of FIG. 1, there is shown the CARDSAFE™ method and apparatus of dual authorization of credit or debit card purchases.

CARDSAFE™ is a system and a method designed for credit and debit card protection. The system and method will require at least two areas of technology: (1) telecommunications and (2) computer networks.

CARDSAFE™ protects the credit or debit card holder by allowing the card holder to pre-approve any and all card transactions associated with a particular credit or debit card or cards. As soon as a particular card is used, the card holder receives immediate or concurrent notification of the transaction. The transaction is not completed or finished until the credit card owner verifies, authorizes or approves of the transaction. In this way, any unauthorized transaction or person who gains access to a particular account would not be able to complete a transaction, or withdraw any funds from the credit or debit card account of the card owner without first obtaining the approval of the card owner.

In FIG. 1, there is shown one particular embodiment of the CARDSAFE™ method and system. It will rely upon computer technology and telecommunications technology, such as Bluetooth®, Blackberry®, or any other Wireless Adaptive Protocol (“WAP”) so that the card holder will have the ability to change this pre-designated number at any time by simply contacting the CARDSAFE™ voicemail system after entering a Personal Identification Number (“PIN”) or secret access code. Once the card holder or owner has been notified, the merchant transaction is delayed until approved first by the card holder who simply returns the call by telephone, Blackberry®, Bluetooth®, WAP, the Internet, or any other such telecommunications methodology, and answers “YES” or “NO” to the menu of options presented.

Such available options include:

1) “YES” for the approval or authorization of a particular transaction; or

2) “NO” for the denial or non-authorization of a particular transaction; or

3) “DELAY” approval for a particular period of time; or

4) “CHANGE” a pre-designated phone number or access code; or

5) “DEACTIVATE” the cardlock mechanism; or

6) “REACTIVATE” the cardlock mechanism; or

7) “LOCATION” to determine the actual location or address at which the transaction is taking place via GPS, Teletrac®, On-Star®, or the like.

Each card holder's or owner's account will have the ability to hold an indefinite number of credit or debit card account numbers.

During each WAP contact or telephone call, CARDSAFE™ will request or indicate which credit or debit card is being used or referenced.

For use in the broadest sense of the term, the CARDSAFE™ system and apparatus will not be limited to any particular type of system, or telecommunications devices or system, but is intended to be a cross-platform or “open” system and apparatus device working with all types of system platforms and devices, including, but not limited solely thereto, telephones, pagers, computers, Personal Data Assistant (“PDA”), Blackberry® by Research In Motion (“RIM®”), Bluetooth®, Motorola's Talkabout®, and the like.

### Typical Usage

The CARDSAFE™ system and apparatus is activated in the following sequence:

1.) Attempted Transaction:

a. CARDSAFE™ calls pre-designated telecommunications number.

b. Account (card) holder receives and answers the telecommunications call.

c. CARDSAFE™ voicemail indicates the following: “A VISA card transaction at (address) is awaiting your approval. Please make a selection from the following menu:

(1) To authorize this transaction, please press “1” Transaction has been approved.”

(2) To deny this transaction, please press “2” Transaction has been cancelled.”

(3) To delay this transaction, press “3” “Please indicate the length of the delay by entering the number of minutes from one to sixty.”

(4) To speak to the person attempting to use the card, press “4”.

(5) To notify the police, press “5”.

(6) To consider further options, press “6”.

(a) Change pre-designated phone number.

(b) Deactivate CardLock™.

The SYSTEM DEACTIVATED mode is accomplished when an authorized card holder is using the card and believes that there is no need for the CardLock™ features of CardSafe™ to be ACTIVE. The SYSTEM can be DEACTIVATED by simply contacting the CardSafe™ Voicemail system and selecting Option No. 6 for “further options” and thereafterwards DEACTIVATING CardLock™ by pressing “2”.

Turning now to the CardSafe™ which is generally illustrated and shown at 10 in FIG. 1 of the drawings herein, there is shown the basic system. The card transaction is typically initiated by the CARD USER with the MERCHANT. Such a card can either be a CREDIT or a DEBIT CARD. A CREDIT card transaction involves a transaction in which a loan takes place and the CARD HOLDER is typically charged through his or her bank or via a statement or invoice. Interest is charged on the amount of the loan usually at an exceptionally high interest rate. A DEBIT card transaction involves the electronic withdrawal of funds directly from the CARD HOLDER's bank or credit union account. No interest is charged on the amount involved because it does not involve a loan. However, a transactional charge is usually involved. The MERCHANT 11 usually “swipes” the card through a slotted magnetic reader mounted or coupled with a modem 12. The magnetically encoded information or data on the card is read and fed as digital pulses into the modem 12 which, in turn, converts the digital pulses into a standard modem compatible digital stream of data which can be received and read into the Public Switch Telephone Network (“PSTN”) 14 and which is electronically routed therethrough and concurrently transmitted to both the modem 13 which notifies the CardSafe™ customer, typically the CARD HOLDER (or OWNER) who is the person who is responsible for paying for the MERCHANT goods or services transaction, and the modem 15 which is operatively connected to the Credit Card Center 16.

The Credit Card Center 16 must then reference a modem 17 electronically connected to a Public Broadcast Exchange (“PBX”) 18 which, in turn, communicates to a Secure DataBase Server 19. The Secure DataBase Server 19 is usually a large commercial high speed, large computer such as an IBM mainframe computer. In turn, the digital stream of signals are fed into a DataBase 20 which is in the form of a combination of a large number of magnetic tape drives or a large number of hard disk drives formed of a plurality of aluminum or glass discs having a magnetic layer thereon, and a large database software such as Oracle, or DB2, or the like. The function of the DataBase 20 is to store the entire transaction by recording the card identification (account) number, the MERCHANT transactional information, and the CARD HOLDER's identification, and the pre-transactional approval or authorization by the CardSafe Customer 21 all in a single transactional file or group of files which is recorded on the magnetic media, either magnetic tape drivers, or hard disk drivers, operatively connected to the Secure DataBase Server 19.

The precise sequence of events to obtain AUTHORIZATION or DENIAL or DELAY of the transaction is as follows. Once the Credit Card Center 16 is in receipt of the transactional information from the MERCHANT 11, it awaits for a digitally encoded AUTHORIZATION or DENIAL or DELAY signal from the CardSafe Customer 21 who has been simultaneously notified by the MERCHANT 11 modem 12 independently of the modem signal notification through the PSTN 14 to the modem 15 located at the Credit Card Center 16. Once notified, the CardSafe Customer 21 enters his selection(s) pursuant to the previously discussed transactional program and the modem 13 translates the CardSafe Customer 21's selections through the PSTN 14 to the modem 12 of the MERCHANT 11 and concurrently to the modem 15 connected to the Credit Card Center 16, and also to the DataBase 20 through the modem 17, the PBX 18 and the Secure DataBase Server 19 where all of the transactional elements via digital signals are recorded.

In the event that there is insufficient funds in the debit card account, or the credit card limit has been exceeded, the Credit Card Center 16 is programmed to transmit a digital signal through the modem 15 through the PSTN 14 to the modem 12 to the MERCHANT 11 to DENY the entire transaction independently of the instructions of the CardSafe Customer 21 through the modem 13.

Concurrently, the CardSafe Customer 21 can also independently AUTHORIZE or DENY or DELAY the transaction by selecting the proper set of digital signals by pressing the proper buttons on his or her transactional input device such as a PDA electronically coupled via WAP, or via a hard wire connection to the modem 13. The CardSafe Customer 21 selected signal from modem 13 is transmitted simultaneously through PSTN 14 to modems 12, 15, 17 to respectively notify the MERCHANT 11, Credit Card Center 16, and the Secure DataBase Server 19 of the selection initiated by the CardSafe Customer 21.

While the basic principles of this invention has been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention, and not construed in a limiting sense.

What I claim as my invention is:

1. A method for effectuating charge card protection by allowing the card holder to exert a final pre-approval of charge card transactions associated with a credit card or debt cards at the time that the charge card is entered at a merchant's modem terminal, consisting of the steps of:
a. swiping a credit card at a merchant's modem terminal to enter the credit card's coded information;
b. transmitting the credit card's coded information from the merchant's modem to the public switch telephone network;
c. transmitting the credit card's coded information from the public switch telephone network concurrently to the credit card center modem and to the card holder modem;
d. the credit card's coded information is fed through the credit card center modem to verify and re-transmit the verified coded to the public broadcast exchange which, in turn, communicates to a secure database server, consisting of a high speed, large mainframe computer which, in turn, receives the digital stream of signals into a database which. in which the entire transaction is stored by recording the card identification (account) number, the merchant transactional information, and the card holder's identification, and the pre-transactional approval or authorization by the CardSafe™ Customer 21 all in a single transactional file or group of files which is recorded on the magnetic media, either magnetic tape drivers, or hard disk drivers, operatively connected to the secure database server, whereby either an authorization or denial or delay of the transaction occurs as follows:
once the credit card center is in receipt of the transactional information from the merchant, it awaits for a digitally encoded authorization or denial or delay signal from the cardsafe customer who has been simultaneously notified by the merchant modem independently of the modem signal notification through the pstn to the modem located at the credit card center and once notified, the cardsafe customer enters his selection(s) pursuant to the previously discussed transactional program and the modem translates the cardsafe customer's selections through the pstn to the modem of the merchant and concurrently to the modem connected to the credit card center, and also to the database through the modem, the pbx and the secure database server where all of the transactional elements via digital signals are recorded, and in the event that there is insufficient funds in the debit card account, or the credit card limit has been exceeded, the credit card center is programmed to transmit a digital signal through the modem through the pstn to the modem to the merchant to deny the entire transaction independently of the instructions of the cardsafe™ customer through the modem.

2. A method for effectuating charge card protection by allowing the card holder to exert a final pre-approval of charge card transactions associated with a credit card or debt cards, consisting of the steps of:
(a) an electronic signal created by a merchant initiated charge card transaction is
(b) At the time that a particular credit card is used in a credit card transaction at a remote terminal, the credit card processing company is contacted with the amount of the transaction and the account number. Concurrently, the card holder is immediately notified by one or more of the currently available electronic or wireless technologies, such as a telephone call, pager notification, wireless, Bluetooth®, Blackberry®, Research In Motion (“RIM®”), Wireless Application Protocol (“WAP”) or the Internet. Upon receipt of this notification, the credit card holder will either approve or disapprove of the credit card transaction by using one or more of the currently available electronic or wireless technologies, such as a telephone call, pager notification, wireless, Bluetooth, Blackberry®, Research In Motion (“RIM®”), Wireless Application Protocol (“WAP”), satellite or the Internet. Unless or until the transaction is approved by the credit card holder, the transaction is not completed. Following notification to the credit card holder, approval or disapproval by the credit card holder can be real time or on a pre-approval or pre-disapproval basis. No credit card transactions can be effectuated without providing the named owner of the credit card an opportunity to approve of, or disapproved of, the credit card transaction. In this way, an unauthorized person who gains access to a particular account would not be able to complete a transaction At the choice of the credit card owner, the CARDSAFE™ system can also be deactivated if desired. The CARDSAFE™ system is designed to work with any and all types of wireless, and wired, systems such as telephones, pagers, microwave, Internet and computers.
